(19) United States
(12) Patent Application Publication
(10) Pub. No.: US 2016/0164107 A1
(43) Pub. Date: Jun. 9, 2016

(54) ELECTRIC POWER GENERATOR USING POTABLE WATER, WITH OXYGEN AND HYDROGEN RELEASE

(71) Applicants: Iuliu IONESCU, County Arges (RO); Alexandru TORDAI, Brasov County (RO)

(72) Inventor: Iuliu IONESCU, Pitesti (RO)

(21) Appl. No.: 14/907,631

(22) PCT Filed: Jul. 28, 2014
(86) PCT No.: PCT/RO2014/000021

§ 371 Date: Jan. 26, 2016

(30) Foreign Application Priority Data
Jul. 26, 2013 (RO) U 2013 00029

(51) Int. Cl. H01M 6/04; H01M 4/38; C25B 11/04; C25B 5/00; C25B 1/04; C25B 9/18; H01M 6/44; H01M 4/46

(52) U.S. Cl. CPC H01M 6/045; H01M 6/44; H01M 4/38; H01M 4/463; C25B 5/00; C25B 1/04; C25B 9/18; C25B 11/04; H01M 2220/30; H01M 2220/10; H01M 2300/0002

(57) ABSTRACT

An electricity generator utilizing drinking water which discharges oxygen and hydrogen based on the differential electronegativity phenomenon of chemical elements, and which uses drinkable water to transfer the electrical loads. By using electrodes having a particular physical structures and which is made of different materials, and which also uses a condenser, an alternative impulse generator and a doubler or a voltage multiplier, stronger power is achieved. In this process, water electrolysis takes place concomitantly wherein gas bubbles appear in the two electrodes. Oxygen is discharged to the anode which is made of an aluminum electrode, and hydrogen is discharged to the cathode which is made of a copper electrode. With a larger generator, oxygen and hydrogen gases may be collected and used to produce heat energy. In the agriculture, medicine, household and other related industries, the electricity generator may also be used.

### CLAIM OF PRIORITY

This application is a continuation application off of International Patent Application No. PCT/RO2014/000021 filed Jul. 28, 2014, which claims Priority from Romanian Application No. U201300029 filed Jul. 26, 2013, the contents of which are both incorporated herein by reference.

### FIELD OF THE EMBODIMENTS

The present invention discloses an electricity generator which uses drinking water, of which discharges oxygen and hydrogen based on the differential electronegativity phenomenon of chemical elements, and which further uses drinkable water to transfer the electrical loads.

### BACKGROUND OF THE EMBODIMENTS

Various system and methods are known in the art. However, their structure and means of operation are substantially different from the present invention. Such devices fail to provide a device that is integrated, controlled electronically by a computer, and will generate heat while in use. At least one embodiment of this invention is presented in the drawings below, and will be described in more detail herein.

### SUMMARY OF THE EMBODIMENTS

The present invention comprises an electricity generator utilizing drinkable water comprising; a container; an electrical insulator container split into several compartments air-sealed between them, each of the several compartment being filled with drinkable water; wherein the interior of each of the several compartments comprising at least one pair of concentric electrodes made from different metals or metal alloys with a high electronegativity difference; wherein the electrodes are connected in series or in parallel; wherein at the container's exit point comprises an electrolytic condenser connected to an impulse generator or an oscillator and connected to a doubler or a voltage multiplier.

The generator further comprises six pairs of metallic electrodes, each of the six pairs of metallic electrodes comprising an electrode made from aluminum and an electrode made from copper. At least one of the six pair of metallic electrodes comprises electrodes made from several layers of jagged plates or a wire mesh shaped like a roll or concentric circles. The drinkable water inside each of the several air-sealed compartments does not contain added salts, acids or organic substances. The drinkable water inside each of the several air-sealed compartments comprises antifreeze-like solutions.

The present invention comprises a generator for generating electricity using water, comprising: at least one conductor, said at least one conductor serially connected to one another; a plastic housing container; said plastic housing container filled with water and comprised of at least one insulator; said at least one insulator comprised of an interior comprising a pair of electrodes; said pair of electrodes comprised of one copper electrode and one aluminum electrode and wherein one electrode has an electronegativity difference higher than the other electrode; and wherein the pair of electrodes are configured to collect at least one gas discharged from the pair of electrodes; an alternative pulse generator; a double voltage multiplier; and an electrolytic condenser.

The insulator is comprised of a plastic tube or pipe. The shape of the pair of electrodes may be spiral or zig zag. The pair of electrodes are comprised of at least one of alloys, treated metals, and other materials. The pair of electrodes may be semiconductors. The pair of electrodes further comprise an anode and a cathode. The generator further comprises splitters between the anode and the cathode. The splitters may be plastic. The at least one gas discharged is oxygen (O₂) or hydrogen (H₂). The pair of electrodes may be comprised of at least one of mesh wire, corrugated sheet and a jagged plate. The pair of electrodes further comprise an upper head for collecting gas. The cathode is comprised of copper, wherein hydrogen gas is discharged to the cathode. The anode is comprised of aluminum, wherein oxygen gas is discharged to the cathode.

### BRIEF DESCRIPTION OF THE DRAWINGS

FIG. 1 shows a perspective illustrative view of the present invention's generator.

FIG. 2a shows an illustrative view of spiraled shaped electrodes.

FIG. 2b shows an illustrative view of wire mesh electrodes.

FIG. 2c shows an illustrative view of jagged or zig zag shaped electrodes.

FIG. 3a shows an illustrative view of several layers of concentric spiral electrodes.

FIG. 3b shows an illustrative view of several layers of roll shaped electrodes.

FIG. 3c shows an illustrative view of several layers of jagged plate or wire mesh electrodes in concentric circles.

FIG. 4 shows a perspective illustrative view of a larger generator.

FIG. 5 shows an illustrative side view of the gas collectors of the present invention.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

For exemplification, the present invention employed six of the generator's elements 20 which may be plastic pipes or other insulator (as shown in FIG. 1), within a plastic housing or container 10, each having in the interior a pair of spiral electrodes, one made of copper 40 and one made of aluminum 30. In another embodiment, some plastic splitters or other insulator should be between the electrodes so as not to touch each other. The elements are serially connected by interconnecting conductors 70, like batteries. The elements' casing can be made of an insulating material or it may even be an electrode. The elements may be comprised of any element such as aluminium, zinc, gold or silver. The electrodes may be comprised of any element such as aluminium, zinc, gold or silver.

A potential difference is created in every element which is of about 0.5 V direct current between the aluminum and copper electrodes. If materials with a higher electronegativity difference are to be used, then the potential will be higher. By connecting in series six elements 70, a potential difference of 3V direct current is created of a very low intensity—measured in microamperes.

The novelty lies in that by using electrodes particular physical structures, made of different materials and adding a condenser, an alternative impulse generator 50 (as shown in FIG. 1 and in FIG. 4) and a doubler or a voltage multiplier 60 (as shown in FIG. 1 and in FIG. 4), useful, stronger power is achieved.

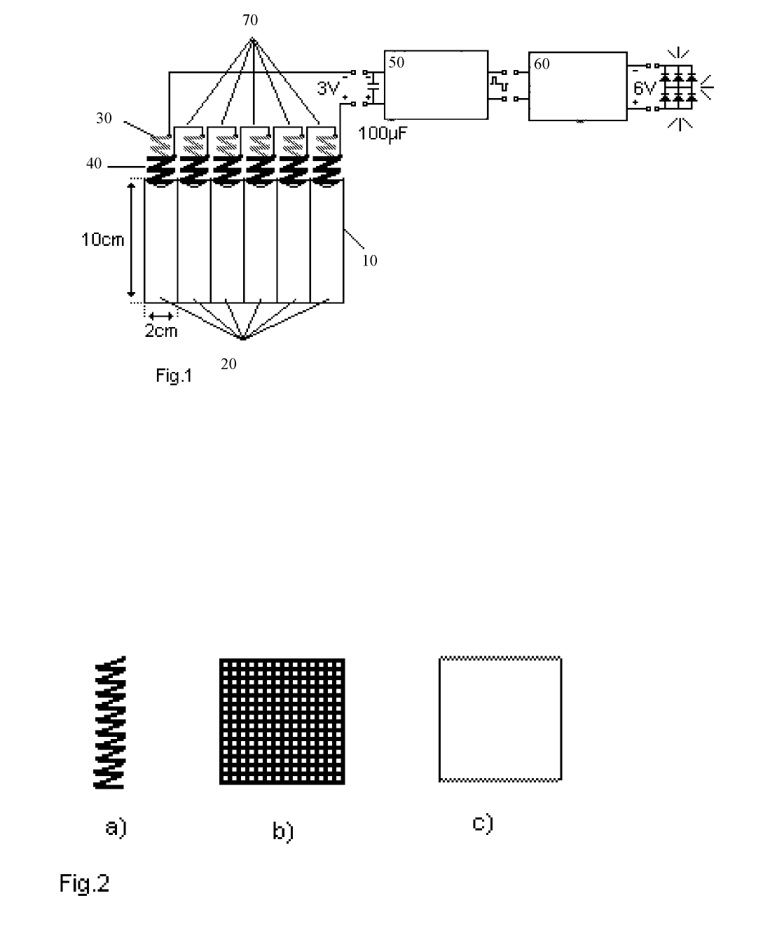

The electrodes may be made out of wire, rods or plates with the diameter or thickness of 3 mm. Other smaller or larger sizes may be chosen as well, depending on their scope. In order to be effective, the electrodes should be spiraled, either from wire mesh from the material of said electrode, or from jagged (zig-zag) plate, (FIG. 2 a, b, c). Such an electrode structure enhances the generator's power by a few times. In another embodiment, other shapes and sizes of the electrodes may be utilized.

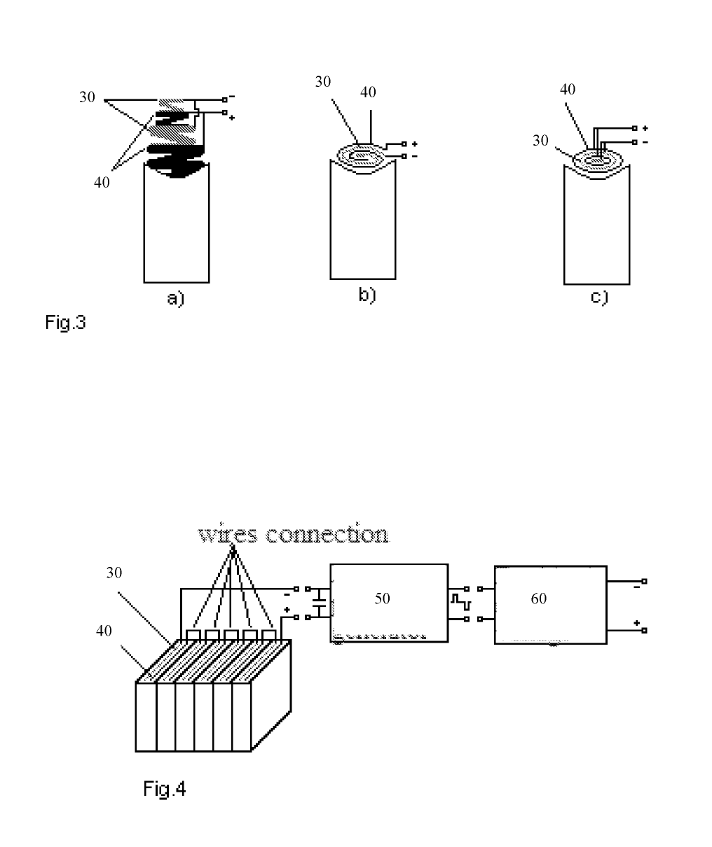

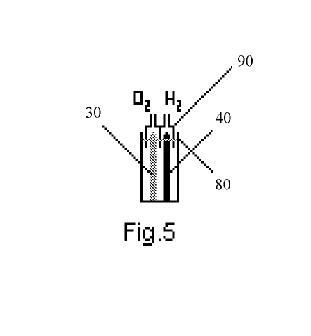

The distance between the cathode and anode can be chosen between 1 and 5 mm placing plastic splitters between them or other insulator. The electrodes, may be made out of spiral wire, wire mesh or corrugated sheet in zig-zag can be concentric even on several layers (the cathode inside the anode or vice-versa). FIG. 1 shows the generators elements including plastic pipes or other insulators. FIG. 2a shows an illustrative view of spiraled shaped electrodes. FIG. 2b shows an illustrative view of wire mesh electrodes. FIG. 2c shows an illustrative view of jagged or zig zag shaped electrodes. FIG. 3a shows an illustrative view of several layers of concentric spiral electrodes, which are comprised of a copper electrode 40 and an aluminum electrode 30. FIG. 3b shows an illustrative view of several layers of roll shaped electrodes. FIG. 3c shows an illustrative view of several layers of jagged plate or wire mesh electrodes in concentric circles. In any of the preferred embodiments, the elements' casing can constitute any type of electrodes such as the anode, or the cathode. FIG. 4 shows a perspective illustrative view of a larger generator. The larger generator may utilize electrodes, a copper electrode 40 and an aluminum electrode 30, shaped like jagged plate sheets or wire mesh. FIG. 5 shows an illustrative side view of the gas collectors 90 of the present invention. Gases yielded can be collected by using the gas collectors which are contained inside the plastic container above the water level 80 line. The gas collectors 90 are disposed on top of the copper electrode 40 and the aluminum electrode 30 which are contained in the plastic container and submerged below the water level 80 line. Collected gases may be used to produce heat energy or in industry, agriculture, medicine etc.

The elements can be as many as desired, connected in series or parallel depending on the energy we want. To become useful, this energy should be amplified both in intensity, and in terms of voltage. Thus, the present invention added an electronic assemblage which solves this problem, so that from one generator with six elements formed of 10 cm long and 2 cm diameter pipes can light up six LEDs with a handmade prototype. Of course, in a factory production, the output can be much better as compared with the handmade prototype. The electronic circuit consists of an electrolytic condenser connected to the generator's terminals, an alternative impulse generator and a doubler or a voltage multiplier. The condenser's role is to enhance the current's intensity between the impulses. The alternative impulse generator has a stimulating effect over the energy output in the generator, also enhancing its intensity. The voltage doubler (or the multiplier) has the function of enhancing the voltage. Such a combination increases the generator's power by a few times.

In this process water electrolysis occurs concomitantly. Gas bubbles appear in the two electrodes. As we know, oxygen discharges to the anode, which is made of an aluminum electrode, and hydrogen to the cathode, in our case the copper electrode. For a larger generator, electrodes shaped like jagged plate sheets or wire mesh can be used (as shown in FIG. 4). The gases yielded can be collected by using collectors (as shown in FIG. 5) and used to produce heat energy or in industry, agriculture, medicine etc.

Water consumption is low. It requires no water change, only addition. The approximate quantity of water to be added is of 10% per month should it be used at maximum capacity. It is possible that within a few years, the anode (the aluminum electrode) may deteriorate, thus requiring replacement. This is dependent upon the water and electrode's composition. This is only for cases where the generator is used permanently at maximum capacity. If it is not used permanently or if it is not used at maximum capacity, the anode's electrodes can last longer. In the breaks between the generator's usage ranges, it doesn't deteriorate, being able to resume its use even after tens or even hundreds of years. For example, a normal flash light used rarely may last without problems for tens or even hundreds of years. The potential deposits on the cathode are insignificant and do not interfere with the process' carry out, since the water is drinkable.

The electrodes can be made of other materials having higher electronegativity difference between the cathode and anode. They can be also made of alloys, treated metals or metal plating, semiconductors, thus extending the electrodes' life and at the same time enhancing the generator's power. Certain substances are added in water so as to extend the electrodes' life and/or substances like “antifreeze” solutions, so that the generator may function below 0 degrees Celsius (32 degrees Fahrenheit).

The generator can be used in any branch of the industry, agriculture, medicine, household appliances etc. It can load accumulators which will generate higher power over shorter periods of time. As opposed to other energy sources, the generator has the following advantages:

1. It doesn't depend on the sun, day or night time.

2. It doesn't depend on the wind.

3. It doesn't pollute the atmosphere.

4. It produces a constant quantity of energy.

5. It can be carried without being demounted, as compared with the solar power-plants or wind power stations.

6. After being manufactured, it can be easily and practically placed and it produces energy immediately.

7. It does not deteriorate over a period of inactivity, unlike accumulators.

8. It can be buried underground (even a water reservoir) which doesn't take up much space and does not cloud the ground like a solar panel. Thus, a temperature of over 0 degrees Celsius is ensured even in the winter without the addition of water.

9. It doesn't contain acids or salts; consequently, it is not dangerous. It can be used also in agriculture with no problems.

10. It can be used even in apartments, which cannot be done with the solar power-plants or wind power stations. A volume of one cubic meter installed in a closet, hall way etc. might be sufficient space.

11. Depending on the generator's volume and on needs, it could ensure on its own the energy required.

12. It can be used to compensate for the temporary lack of energy when other generators are not enough (solar, wind etc.).

13. Other sources can be supplemented permanently when more energy is required, with one safe, reliable source which does not lead to unpredictable difficulties.

14. It does not have a high cost, having regard to the fact that only once in several years (and upon extensive use) will require only the change of the anode's electrodes.

15. It can be used only in areas where an electrical network cannot be implemented, nor will the generator exploit the solar or wind energy.

16. Unlike an accumulator, the generator is useful in difficult of inaccessible areas where constant energy is needed, or where over a period of many years frequent change is hard to do, such as underground, under water or even in space and the cosmos.

In another embodiment, the container may have a multitude of dimensions, and can have many forms depending on the generator's use. The condenser may be an electrolytic condenser. The alternative impulse generator is a generator which generators a series of impulses wherein a negative impulse is followed by a positive impulse and vice versa. The oscillator may generate impulses in sinusoidal form. The alternative impulse generator generates impulses where there are spaces between the electrodes (as shown in FIG. 1 and FIG. 4). The voltage doubler or voltage multiplier is a doubler or multiplication electronic device, made only with condensers and diodes, and which amplifies the tension without the need of a transformation or other transformer device. As shown in FIG. 1 and in FIG. 4, the exiting terminals from the generator are located on the right side, marked with a positive (+) and a negative (−). Also, as shown in FIG. 1 and in FIG. 4, the terminals are connected to 6 Light Emitting Diodes (LED's). The LED's are marked as diodes, since LED's are in fact diode units.

In another embodiment, the generator may function without the gas collectors shown in FIG. 5 and thus not emit gases. In assembling the unit, the anode and cathode units are placed inside a container. These can be connected together in series or in parallel, just like you would do for batteries. At the exit terminals, a condenser is connected. After that, an alternative impulse generator or an oscillator is connected. Finally, a doubler or a voltage multiplication device (tension, current multiplication unit) is also connected. At the end of the terminals, a consumer device such as LED lights are connected.

In another embodiment, the generator may work with any number of pipes or generator cells. The tension (or voltage) is affected only by the style and method of connecting these pipes or generator cells together. If they are connected in series, then the voltage tension will rise. If they are connected in parallel, then the intensity will be stronger (as measured in miliAmpere). The doubler or voltage multiplier enables stronger power to be achieved. Stronger power is achieved, by the form of a signal; by the “pause” between impulses. In another embodiment, the distance between the anode and cathode affect the generating of electricity. When the anode is closer to the cathode, the power is bigger. In another embodiment, the temperature of the drinkable matter affects the electricity generated. If then drinkable water is “hard water” it can be easily filtered prior to be used in the generator. In another embodiment, rain water may be captured and used in the generator.

The generator powers itself by taking energy from the matter itself. Generated energy appears because of the potential electronegativity difference between the chemical elements of the metals (electrodes) and the extraction of this energy can be amplified if the correct electrical circuits are chosen. The generator creates an electrical current which can be used in any field, where electrical current is needed. For example, in another embodiment, the generator may be used on a plant farm, or animal farm, which need constant humidity, and light during the night, as they usually are present in regions where no electrical power is present. Also, in such farms, the generator may power video surveillance cameras and alarm systems. In another embodiment, the generator may be used in an atomic bunker. These bunkers cannot use wind or solar power, since those are ground level, exposed and can be damaged during an atomic war event. In this embodiment, the water will be able to be harvested from the ground up, or stored in the bunker. The present invention is a considerably cheaper electricity generation alternative when compared to other methods and when compared to batteries. As compared to batteries, the present invention may generate the same amount of energy but is cheaper and the pollution caused by batteries is eliminated as well.

While this disclosure refers to exemplary embodiments, it will be understood by those skilled in the art that various changes may be made and equivalents may be substituted for elements thereof without departing from the scope of the disclosure. In addition, many modifications will be appreciated by those skilled in the art to adapt a particular instrument, situation or material to the teachings of the disclosure without departing from the spirit thereof. Therefore, it is intended that the disclosure not be limited to the particular embodiments disclosed.

When introducing elements of the present disclosure or the embodiment(s) thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements.

Therefore, it is intended that the disclosure not be limited to the particular embodiments disclosed.

What is claimed is:

1. An electricity generator utilizing drinkable water comprising;
a container;
an electrical insulator container split into several compartments air-sealed between them, each of the several compartment being filled with drinkable water;
wherein the interior of each of the several compartments comprising at least one pair of concentric electrodes made from different metals or metal alloys with a high electronegativity difference;
wherein the electrodes are connected in series or in parallel;
wherein at the container's exit point comprises an electrolytic condenser connected to an impulse generator or an oscillator and connected to a doubler or a voltage multiplier.

2. The generator according to claim 1, further comprising six pairs of metallic electrodes, each of the six pairs of metallic electrodes comprising an electrode made from aluminum and an electrode made from copper.

3. The generator according to claim 1, wherein the at least one of the six pair of metallic electrodes comprises electrodes made from several layers of jagged plates or a wire mesh shaped like a roll or concentric circles.

4. The generator according to claim 1, wherein the drinkable water inside each of the several air-sealed compartments does not contain added salts, acids or organic substances.

5. The generator according to claim 1, wherein the drinkable water inside each of the several air-sealed compartments comprises antifreeze-like solutions.

6. A generator for generating electricity using water, comprising:
at least one conductor, said at least one conductor serially connected to one another;
a plastic housing container; said plastic housing container filled with water and comprised of at least one insulator; said at least one insulator comprised of an interior comprising a pair of electrodes; said pair of electrodes comprised of one copper electrode and one aluminum electrode and wherein one electrode has an electronegativity difference higher than the other electrode; and
wherein the pair of electrodes are configured to collect at least one gas discharged from the pair of electrodes;
an alternative pulse generator;
a double voltage multiplier; and
an electrolytic condenser.

7. The generator of claim 6 wherein the insulator is comprised of a plastic tube or pipe.

8. The generator of claim 6, wherein the shape of the pair of electrodes may be spiral or zig zag.

9. The generator of claim 6, wherein the pair of electrodes are comprised of at least one of alloys, treated metals, and other materials.

10. The generator of claim 6, wherein the pair of electrodes may be semiconductors.

11. The generator of claim 6, wherein the pair of electrodes further comprise an anode and a cathode.

12. The generator of claim 6, further comprising splitters between the anode and the cathode.

13. The generator of claim 12, wherein the splitters may be plastic.

14. The generator of claim 6, wherein the at least one gas is oxygen (O₂) or hydrogen (H₂).

15. The generator of claim 6, wherein the pair of electrodes may be comprised of at least one of mesh wire, corrugated sheet and a jagged plate.

16. The generator of claim 6, wherein the pair of electrodes further comprise an upper head for collecting gas.

17. The generator of claim 6, wherein the cathode is comprised of copper.

18. The generator of claim 6, wherein hydrogen gas is discharged to the cathode.

19. The generator of claim 6, wherein the anode is comprised of aluminum.

20. The generator of claim 6, wherein oxygen gas is discharged to the cathode.
